(19) United States
(12) Patent Application Publication
(10) Pub. No.: US 2024/0166831 A1
(43) Pub. Date: May 23, 2024

(54) UR-TYPE POLYIMIDE RESIN APPLICABLE TO REINFORCED MATERIAL STRUCTURE

(71) Applicant: YU- LING CHEN, New Taipei City (TW)

(72) Inventor: YU- LING CHEN, New Taipei City (TW)

(21) Appl. No.: 18/381,256

(22) Filed: Oct. 18, 2023

(30) Foreign Application Priority Data
Nov. 21, 2022 (TW) 111144332

(51) Int. Cl. C08J 5/24; B32B 5/02; B32B 15/14; C08J 3/20; C08K 3/04; C08K 7/06

(52) U.S. Cl. CPC C08J 5/243; B32B 5/024; B32B 15/14; C08J 3/203; C08K 3/04; C08K 7/06; B32B 2260/021; B32B 2260/046; B32B 2262/106; C08J 2379/08

(57) ABSTRACT

A UR-type polyimide resin applicable to reinforced material structure is provided, essentially provided in the form of a UR-type (polyurea-imind, URI) polyimide resin (polyurea-imide resin), and synthesized by polymerization of three monomers, namely dianhydride, diisocyanate, and diamine. The UR-type polyimide resin thus synthesized is transparent, brownish, and highly viscous. Since its pyrolysis temperature is above 500° C., the UR-type polyimide resin is, together with a fiber material, used to produce a fiber composite or produce a metallic composite coated on or thinly adhered to the surface of a metallic material, allowing products of the disclosure to demonstrate excellent heat resistance, mechanical properties, electrical properties, and chemical properties.

### BACKGROUND OF THE INVENTION

### 1. Field of the Invention

The present disclosure relates to a UR-type polyimide resin applicable to reinforced material structure, and more particularly to a UR-type polyimide resin for use in fiber fabric impregnation processing and metallic material coating processing or thin-film adherence processing, allowing products of the disclosure to feature excellent heat resistance, mechanical properties, electrical properties, and chemical properties.

### 2. Description of Related Art

In recent years, some car hoods were made of conventional resins and carbon fiber fabrics; although the car hoods thus made were lightweight and visually attractive when installed in place, they discolored six months later and malfunctioned a year later, ending up with a failure because of poor heat resistance and low weatherability. Similarly, motorbike exhaust pipes made of conventional resins and carbon fiber fabrics looked attractive initially but malfunctioned soon for reasons as follows: motorbike exhaust temperature of around 220° C., and poor heat resistance of conventional resins. Owing to their excellent characteristics, such as high heat resistance, high weatherability, high aging resistance, and high mechanical properties, composites made of the resin of the disclosure have wide applications. There is a great potential for replacing metallic materials with carbon fiber composites, not only because fiber composites have never been made of polyimide, but also because the UR-type polyimide resin of the disclosure demonstrates excellent impact resistance, high resilience, and high crack resistance.

### SUMMARY OF THE INVENTION

It is therefore an objective of the disclosure to provide a UR-type polyimide resin applicable to reinforced material structure. The UR-type polyimide resin is a high-performance resin that manifests advantages intrinsic to polyimide resin and urea resin. The adherence of the UR-type polyimide resin to fibers or metals is satisfactory; thus, for example, composites made of UR resin/fiber or composites made of UR resin/metal promise wide applications.

According to the disclosure, a UR-type polyimide resin applicable to reinforced material structure serves the purpose of fiber fabric impregnation processing or serves the purpose of metallic material coating processing or thin-film adherence processing. The UR-type polyimide resin is synthesized by polymerization of three monomers, namely dianhydride, diisocyanate, and diamine. After its surface has been subjected to heat treatment, a fiber fabric is impregnated with the UR-type polyimide resin in a liquid state. Then, the fiber fabric is heated and compressed to form a composite board. In particular, the fiber fabric is impregnated with the UR-type polyimide resin in a liquid state to attain a three-dimensional fiber composite advantageously characterized by light weight, high mechanical strength, and high vibration resistance. Furthermore, a composite board produced from a three-dimensional woven fabric is free of a drawback, i.e., delamination, because the three-dimensional fiber fabric is fiber-reinforced in its thickness direction. In this regard, the fibers for use in reinforcement include carbon fiber, glass fiber and aramid fiber, and carbon fiber composites can substitute for vehicular metallic boards to not only reduce the weight of vehicles but also render the vehicles visually attractive.

The UR-type polyimide resin prepared in a liquid state or the UR-type polyimide resin stretched, heated and compressed to be in the form of thin film can be coated on or adhered to the surfaces of metallic materials, for example, the surfaces of the metallic frames of offshore wind turbines to protect them against erosion by seawater and wind.

A fiber fabric can be impregnated with the UR-type polyimide resin. The UR-type polyimide resin can be coated on or thinly adhered to the surface of a metallic material. Therefore, products of the disclosure have characteristics as follows:
1. Products of the disclosure demonstrate excellent heat resistance and high thermal stability, being good at withstanding extreme heat, extreme cold, thermal expansion and contraction.
2. Products of the disclosure demonstrate high resilience, high wear resistance, high scratch resistance, high crack resistance, and high aging resistance.
3. Products of the disclosure demonstrate excellent impact resistance, chemical proofing, weatherability, and radiation resistance.
4. Products of the disclosure demonstrate excellent mechanical properties and excellent electrical properties.
5. Products of the disclosure are verified by tests to have a tensile strength of 85.15 Mpa, elongation at break of 5.54%, dielectric constant of 2.81 ε, dissipation factor tan δ≤0.003, and water absorption rate of 2.61%, as the UR polyimide resin thin film and a metallic material are laminated together, heated and compressed to form a metallic composite.

### BRIEF DESCRIPTION OF THE DRAWINGS

FIG. 1 shows TGA curves of a UR-type polyimide resin applicable to reinforced material structure according to the disclosure.

FIG. 2 is a graph of the deflection of the UR-type polyimide resin applicable to reinforced material structure under a non-oscillating load versus temperature according to the disclosure.

FIG. 3 schematically depicts the tensile rupture work of carbon fiber composites with different three-dimensional structures according to the disclosure.

FIG. 4 schematically depicts the flexural strength of carbon fiber composites with different three-dimensional structures according to the disclosure.

FIG. 5 schematically depicts the flexural rupture work of carbon fiber composites with different three-dimensional structures according to the disclosure.

FIG. 6 schematically depicts the shear strength of carbon fiber composites with different three-dimensional structures according to the disclosure.

FIG. 7 is a graph of load versus deflection of carbon fiber composites with different three-dimensional structures according to the disclosure.

FIG. 8 is a graph of retention of flexural strength (%) versus temperature (° C.) of carbon fiber composites with different three-dimensional structures according to the disclosure.

FIG. 9 is a graph of peel strength (kgf/cm) versus temperature (° C.) based on the result of a peel strength test performed under different pressures on a metallic composite formed by laminating together, heating and compressing the UR-type polyimide resin thin film and a metallic material according to the disclosure.

FIG. 10 schematically depicts a carbon fiber composite made of the UR-type polyimide resin applicable to reinforced material structure according to the disclosure.

FIG. 11 schematically depicts a metallic material composite made of the UR-type polyimide resin applicable to reinforced material structure according to the disclosure.

### DETAILED DESCRIPTION OF THE INVENTION

The disclosure provides a UR-type polyimide resin applicable to reinforced material structure. The UR-type polyimide resin is synthesized by polymerization of three monomers, namely dianhydride, diisocyanate, and diamine, essentially applied to fiber fabric impregnation processing and metallic material coating processing or thin-film adherence processing. The characteristics of a composite formed by coupling carbon fibers to the resin depend on the direction in which fibers in a carbon fiber fabric are arranged and the distance by which the fibers are spaced apart.

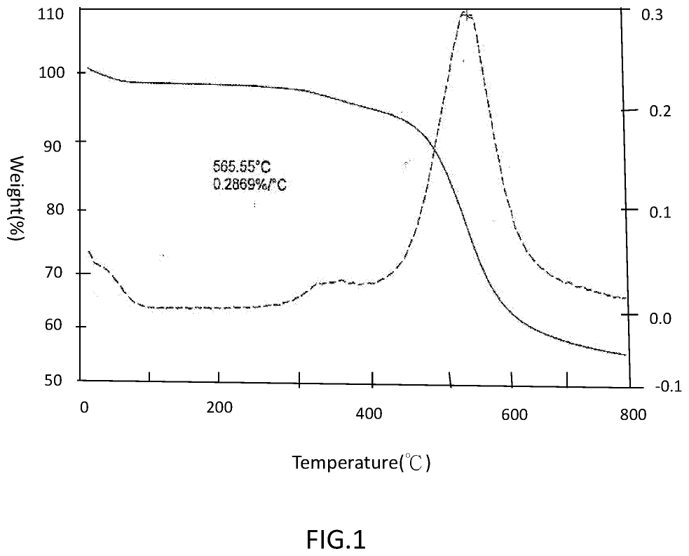

Referring to FIG. 1, there are shown TGA curves of a UR-type polyimide resin applicable to reinforced material structure according to the disclosure. The TGA curves obtained by performing thermogravimetric analysis (TGA) on the UR-type polyimide resin with high heat resistance, as shown in FIG. 1. Referring to FIG. 1, the UR-type polyimide resin incurs a 10% thermogravimetric loss at around 500° C. and the maximum thermogravimetric loss at 565.56° C., confirming the excellent heat resistance of the UR-type polyimide resin.

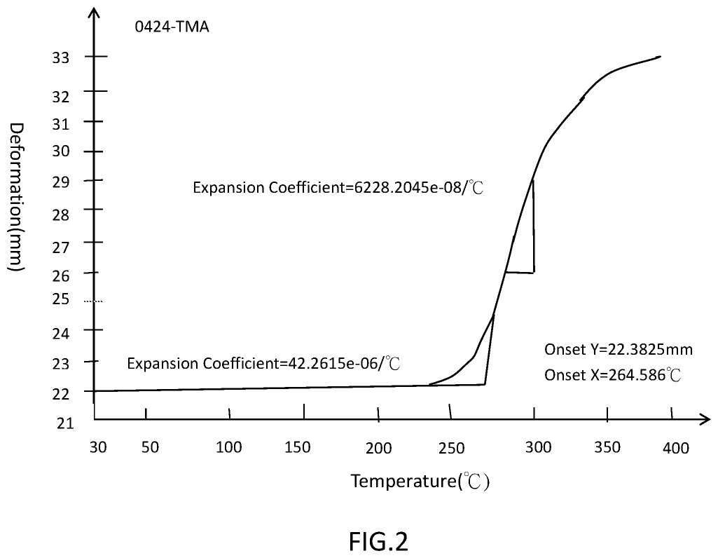

Referring to FIG. 2, it schematically depicts a graph of the deflection of the UR-type polyimide resin applicable to reinforced material structure under a non-oscillating load versus temperature according to the disclosure. The dimensions stability of a material can be evaluated by measuring its coefficient of thermal expansion, because the material undergoes decomposition or rupture at a high temperature whenever there is an overly great difference in the coefficient of thermal expansion between the material and its adhesive substrate. As shown in FIG. 2, given a thermal deformation temperature Tg of 264.566° C., the UR-type polyimide resin has a viscosity of 0.83 to 0.91 dl/g.

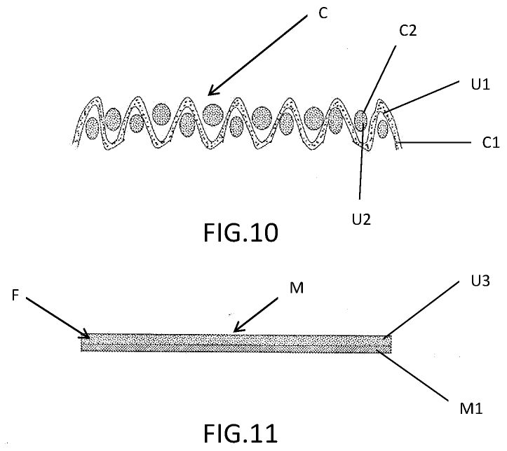

The method of producing a carbon fiber composite comprises the steps of:
(1) Weaving fabrics with four three-dimensional structures, namely in three directions (x-axis, y-axis, and z-axis), in five directions (x-axis, y-axis, z-axis, +45° x¹-axis, and −45° x²-axis), with a fabric set of 5.0 mm, and with a fabric set of 7.5 mm, each having dimensions of 150 mm×150 mm×6 mm;
(2) Placing the fabrics in a steel box filled with the UR-type polyimide resin in a liquid state to impregnate the fabrics with the UR-type polyimide resin; and
(3) Placing the fabrics impregnated with the UR-type polyimide resin in a vacuum oven and then heating up the fabrics until the solution is fully evaporated, so as to form the carbon fiber composite. As shown in FIG. 10, carbon fiber composite C comprises weft fiber yarns C1 with resin U1 and warp fiber yarns C2 with resin U2.

The table below shows the result of a fiber content test performed on different fabric structures. As revealed in the table, the fiber content of different fabric structures falls within the range of 55% to 57% and thus is substantially equal to the fiber content theoretically estimated.

| Item | 2D | 3D-5.0 | 3D-7.5 | 5D-5.0 | 5D-7.5 |
|---|---|---|---|---|---|
| theoretical | 55.0% | 56.0% | 54.0% | 57.5% | 55.0% |
| fiber volume | | | | | |
| content | | | | | |
| actual fiber | 56.2% | 55.3% | 55.6% | 57.0% | 56.2% |
| volume | | | | | |
| content | | | | | |

In an embodiment of the disclosure, the carbon fibers (dimension—fabric set) come in five specifications, namely 2D (two-dimensional—0.0 mm), 3D—5.0 (three-dimensional—5 mm), 5D—5.0 (five-dimensional—5 mm), 3D—7.5 (three-dimensional13 7.5 mm), and 5D—7.5 (five-dimensional—7.5 mm), in order to be woven to produce carbon fiber composites (150 mm×150 mm×6 mm).

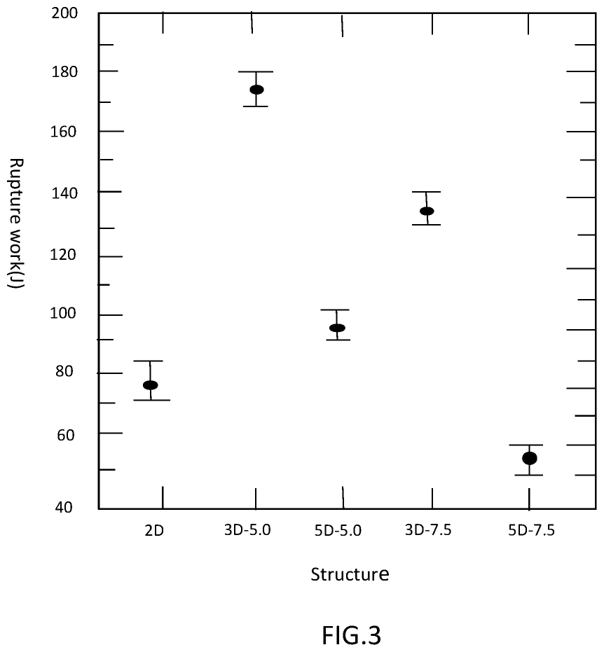

FIG. 3 schematically depicts the tensile rupture work of carbon fiber composites with different three-dimensional structures according to the disclosure. As shown in FIG. 3, the horizontal axis represents fabric structure, and the vertical axis represents rupture work (J), with the fabric structures denoted by 2D, 3D—5.0, 5D—5.0, 3D—7.5, and 5D—7.5, and the test results denoted by 2D—79J, (3D—5.0)—180J, (5D—5.0)—99J, (3D—7.5)—130J, and (5D—7.5)—50J.

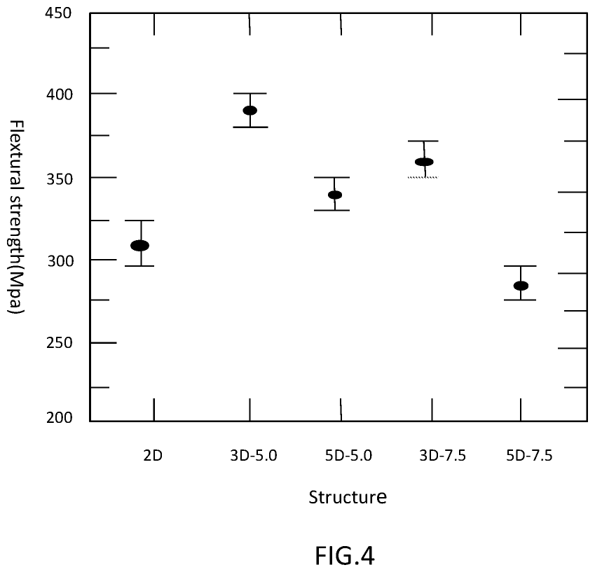

FIG. 4 schematically depicts the flexural strength of carbon fiber composites with different three-dimensional structures according to the disclosure. As shown in FIG. 4, the horizontal axis represents fabric structure, and the vertical axis represents flexural strength (Mpa), with the fabric structures denoted by 2D, 3D—5.0, 5D—5.0, 3D—7.5, and 5D—7.5, and the test results denoted by 2D—300Mpa, (3D—5.0)—388Mpa, (5D—5.0)—358Mpa, (3D—7.5)—368Mpa, and (5D—7.5)—285Mpa, confirming that 3D>5D>2D in terms of the flexural strength of the carbon fiber composites.

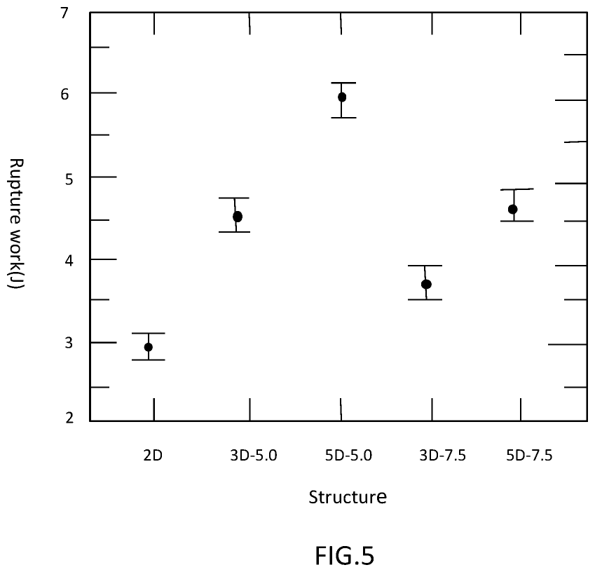

FIG. 5 schematically depicts the flexural rupture work of carbon fiber composites with different three-dimensional structures according to the disclosure. As shown in FIG. 5, the horizontal axis represents fabric structure, and the vertical axis represents flexural rupture work (J), with the fabric structures denoted by 2D, 3D—5.0, 5D—5.0, 3D—7.5, and 5D—7.5, and the test results denoted by 2D—3J, (3D—5.0)—4.5J, (5D—5.0)—6J, (3D—7.5)—4J, and (5D—7.5)—4.5J.

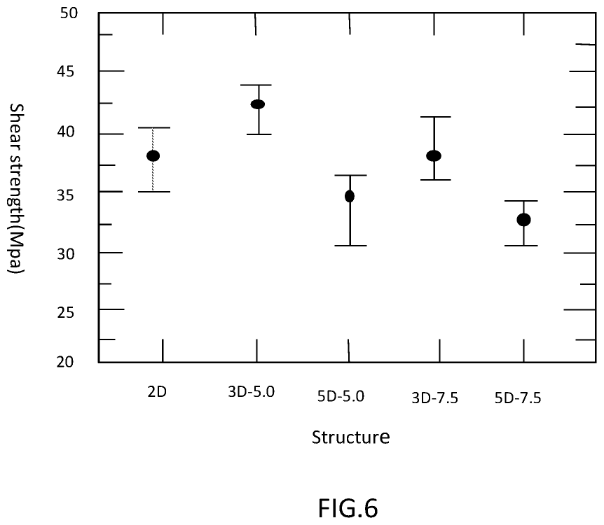

FIG. 6 schematically depicts the shear strength of carbon fiber composites with different three-dimensional structures according to the disclosure. As shown in FIG. 6, the horizontal axis represents fabric structure, and the vertical axis represents shear strength (Mpa), with the fabric structures denoted by 2D, 3D—5.0, 5D—5.0, 3D—7.5, and 5D—7.5, and the test results denoted by 2D—38.8 Mpa, (3D—5.0)—42.5 Mpa, (5D—5.0)—35 Mpa, (3D—7.5)—40 Mpa, and (5D—7.5)—33.8 Mpa.

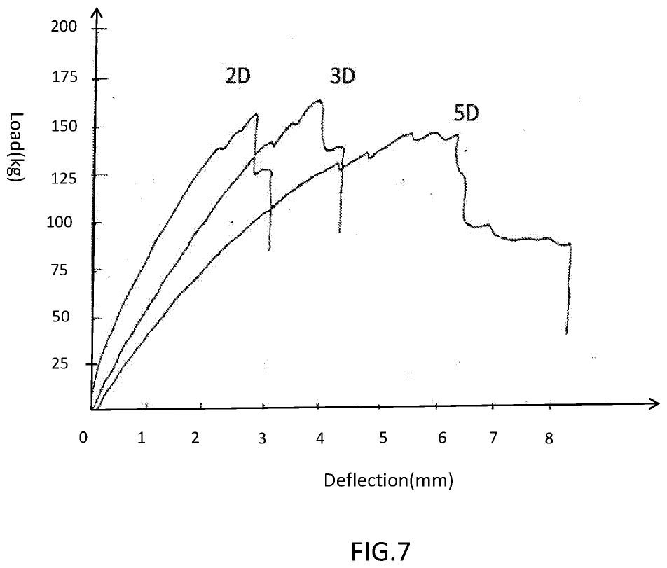

FIG. 7 is a graph of load versus deflection based on the result of a flexure test performed on carbon fiber composites with different three-dimensional structures according to the disclosure. As shown in FIG. 7, the horizontal axis represents deflection, and the vertical axis represents load (kg). The findings of the test are as follows: 2D carbon fiber composite fabric undergoes a deflection of 2.5 mm and thus gets damaged under a load of 150 kg, 3D carbon fiber composite fabric undergoes a deflection of 3.5 mm and thus gets damaged under a load of 165 kg, and 5D carbon fiber composite fabric undergoes a deflection of 6 mm and thus gets damaged under a load of 138 kg, confirming that 3D>2D>5D in terms of the performance of the carbon fiber composite fabrics in the flexure test.

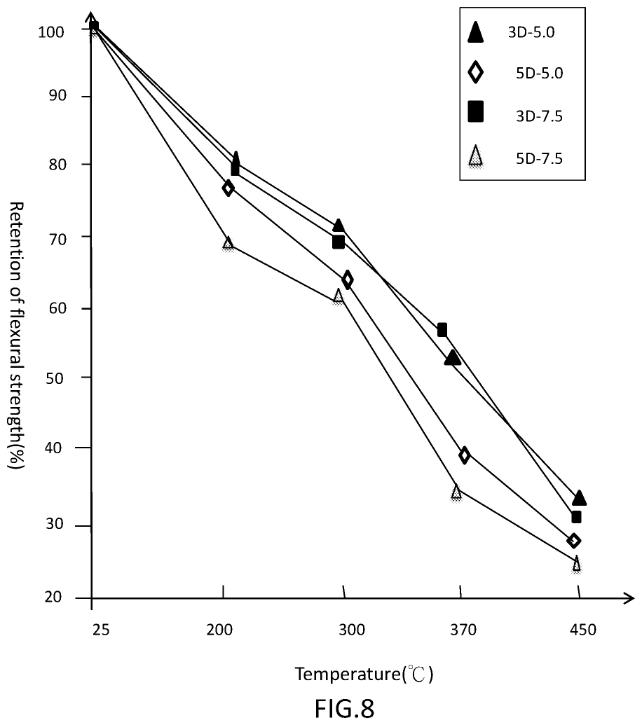

FIG. 8 shows graphs of retention of flexural strength (%) versus temperature (° C.) of a flexural strength retention test performed on carbon fiber fabric composites at different temperatures, with horizontal axis representing temperature (CC), and vertical axis representing retention of flexural strength (%). The test is performed on carbon fiber composite fabrics denoted by ▴3D—5.0, ⋄5D—5.0, ▪3D—7.5, and Δ5D—7.5. The findings of the test are as follows: at 200° C., ♦3D—5.0 carbon fiber composite demonstrates a retention of flexural strength of 80%, ⋄5D—5.0 carbon fiber composite demonstrates a retention of flexural strength of 75%, ▪3D—7.5 carbon fiber composite demonstrates a retention of flexural strength of 79%, and Δ5D—7.5 carbon fiber composite demonstrates a retention of flexural strength of 70%; at 300° C., ▴3D—5.0 carbon fiber composite demonstrates a retention of flexural strength of 78%, ⋄5D—5.0 carbon fiber composite demonstrates a retention of flexural strength of 63%, ▪3D—7.5 carbon fiber composite demonstrates a retention of flexural strength of 70%, and Δ5D—7.5 carbon fiber composite demonstrates a retention of flexural strength of 60%; at 370° C. , ▴3D—5.0 carbon fiber composite demonstrates a retention of flexural strength of 54%, ⋄5D—5.0 carbon fiber composite demonstrates a retention of flexural strength of 40%, ▪3D—7.5 carbon fiber composite demonstrates a retention of flexural strength of 57%, and Δ5D—7.5 carbon fiber composite demonstrates a retention of flexural strength of 35%; at 450° C., ▴3D—5.0 carbon fiber composite demonstrates a retention of flexural strength of 33%, ⋄5D—5.0 carbon fiber composite demonstrates a retention of flexural strength of 28%, ▪3D—7.5 carbon fiber composite demonstrates a retention of flexural strength of 30%, and Δ5D—7.5 carbon fiber composite demonstrates a retention of flexural strength of 25%.

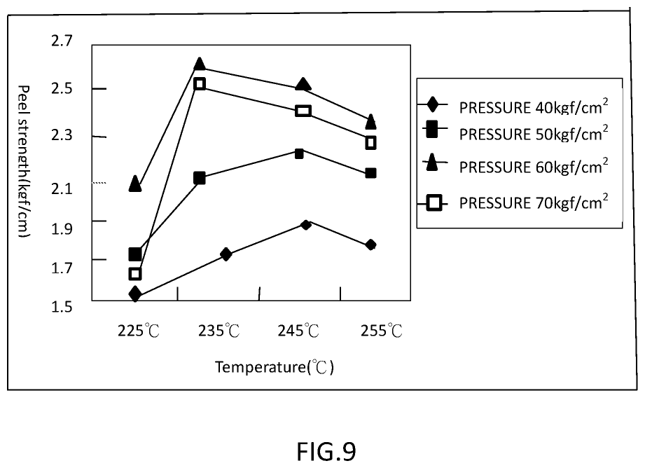

Referring to FIG. 9, there is shown a graph of peel strength (kgf/cm) versus temperature (° C.) based on the result of a peel strength test performed under different pressures on a metallic composite formed by laminating together, heating and compressing the UR-type polyimide resin thin film and a metallic material according to the disclosure. The findings of the test are as follows: a peel strength of 1.9 kgf/cm under ♦ pressure of 40 kgf/cm² at 245° C., a peel strength of 2.2 kgf/cm under ▪ pressure of 50 kgf/cm² at 245° C., a peel strength of 2.65 kgf/cm under ♦ pressure of 60 kgf/cm² at 235° C., and a peel strength of 2.5 kgf/cm under □ pressure of 70 kgf/cm² at 235° C., confirming that the peel strength varies with temperature and pressure. As shown in FIG. 11, metallic composite M comprises resin U3 provided in the form of thin film F to be adhered to metallic board M1.

What is claimed is:

1. A UR-type polyimide resin applicable to reinforced material structure, allowing a carbon fiber composite with the reinforced material structure to be impregnated with the UR-type polyimide resin, the UR-type polyimide resin being synthesized by polymerization of three monomers, namely dianhydride, diisocyanate, and diamine, and used in weaving fabrics in three-dimensional directions (x-axis, y-axis, and z-axis), and in five-dimensional directions (x-axis, y-axis, z-axis, +45° x¹-axis, and −45° x²-axis), with two different fabric sets, placing the fabrics in a steel box filled with the UR-type polyimide resin in a liquid state to impregnate the fabrics with the UR-type polyimide resin, and placing the fabrics impregnated with the UR-type polyimide resin in a vacuum oven and then heating up the fabrics until a solution is fully evaporated, so as to form the carbon fiber composite.

2. The UR-type polyimide resin applicable to reinforced material structure according to claim 1, wherein the UR-type polyimide resin has a heat resistance temperature of above 500° C.

3. The UR-type polyimide resin applicable to reinforced material structure according to claim 1, wherein the UR-type polyimide resin has a thermal deformation temperature Tg of 200 to 300° C.

4. The UR-type polyimide resin applicable to reinforced material structure according to claim 1, wherein the UR-type polyimide resin demonstrates excellent heat resistance and has a viscosity of 0.83 to 0.91 dl/g.

5. The UR-type polyimide resin applicable to reinforced material structure according to claim 1, wherein the carbon fiber composite thus formed has a fiber content of 55 to 57%

6. The UR-type polyimide resin applicable to reinforced material structure according to claim 1, wherein carbon fibers of the carbon fiber composite thus formed come in five specifications in dimensions and fabric sets, namely 2D (two-dimensional—0.0 mm), 3D—5.0 (three-dimensional—5 mm), 5D—5.0 (five-dimensional—5 mm), 3D—7.5 (three-dimensional—7.5 mm), and 5D—7.5 (five-dimensional—7.5 mm).

7. The UR-type polyimide resin applicable to reinforced material structure according to claim 1, wherein the carbon fiber composite thus formed has a flexural strength of 300 to 388 Mpa.

8. The UR-type polyimide resin applicable to reinforced material structure according to claim 1, wherein the carbon fiber composite thus formed has a shear strength of 35 to 42.5 Mpa.

9. A UR-type polyimide resin applicable to reinforced material structure, allowing a metallic composite with the reinforced material structure to be for use in thin-film adherence, the UR-type polyimide resin being synthesized by polymerization of three monomers, namely dianhydride, diisocyanate, and diamine, and used to produce the metallic composite thinly adhered to or coated on a surface of a metallic material.

10. The UR-type polyimide resin applicable to reinforced material structure according to claim 9, wherein the metallic composite has a peel strength of 1.9 to 2.65 kgf/cm.
